(19) United States
(12) Patent Application Publication
(10) Pub. No.: US 2015/0017073 A1
(43) Pub. Date: Jan. 15, 2015

(54) EXHAUST GAS CLEANING DEVICE

(71) Applicant: VOLKSWAGEN AKTIENGESELLSCHAFT, Wolfsburg (DE)

(72) Inventor: Stefan Tölle, Mackendorf (DE)

(21) Appl. No.: 14/384,038

(22) PCT Filed: Feb. 8, 2013
(86) PCT No.: PCT/EP2013/052547

§ 371 Date: Sep. 9, 2014

(30) Foreign Application Priority Data
Mar. 10, 2012 (DE) 10 2012 017 178.1

(51) Int. Cl. F01N 3/021; B01D 46/00; B01D 53/75; B01D 53/04

(52) U.S. Cl. CPC F01N 3/021; B01D 53/0407; B01D 46/0002; B01D 53/75
USPC 422/169; 96/152; 55/502

(57) ABSTRACT

The invention relates to an exhaust gas cleaning device (10) comprising a) a housing (14) through which an exhaust gas flow (12) can flow; b) an exhaust gas cleaning component (16) that is arranged in the housing (14), which component comprises a carrier (20) which has an end face (22, 24) on the inlet side and on the outlet side and through which the exhaust gas flow (12) can flow; c) at least one separation element (26, 40) that is arranged upstream of the exhaust gas cleaning component (16), which separation element separates an exhaust gas flow path into at least two parallel flow paths (28, 30); and d) at least one sealing means (38, 42) provided in the region of the end face (22) on the inlet side of the carrier (20) and/or of a downstream end of the separation element (26, 40), and that is suitable to counteract a cross flow of the exhaust flow (12) between the at least two parallel flow paths (28, 30).

The invention relates to an exhaust-gas cleaning device as well as to an exhaust-gas system comprising such a device, especially for internal combustion engines.

The state of the art discloses exhaust-gas cleaning devices in which, upstream from an exhaust-gas converter, the exhaust-gas path is divided by an inner tube into a central flow path and a peripheral flow path (e.g. German patent application DE 103 50 516 A). One of these parallel flow paths, especially the peripheral flow path, can contain an exhaust-gas catalyst. Suitable actuators serve to convey the exhaust-gas stream via the peripheral flow path through the annular exhaust-gas cleaning means or else to bypass the latter via the central flow path. Such an arrangement is known, for example, in conjunction with a downstream three-way catalyst upstream from which there is an adsorber for hydrocarbons (HC adsorber) in one of the parallel flow paths. As long as the main catalyst has not yet reached its operating temperature after the engine has been started, the exhaust-gas stream is conveyed via the peripheral HC adsorber that temporarily stores the hydrocarbons that are present in the exhaust gas. As soon as the downstream catalyst has reached its operating temperature, the exhaust-gas stream is conveyed via the central flow path so as to bypass the HC adsorber and to heat it up. Once the HC adsorber has reached its desorption temperature, the exhaust gas is once again conveyed partially or completely through the HC adsorber in order to discharge the released hydrocarbons and to transport them into the main catalyst, where they are catalytically converted. This arrangement permits a very good reduction of HC start-up emissions. However, the production of an annular catalyst support is relatively complicated.

German patent application DE 26 27 596 A describes a holder for a catalyst support in a catalyst housing, whereby, along the circumference of the front faces of the catalyst support, a sealing ring is placed onto each support where it widens conically towards the housing and is in contact with it.

The present invention is based on the objective of putting forward an exhaust-gas cleaning device which entails the possibility of exhaust-gas lines that can be connected in parallel and which has a simpler design than prior-art devices such as those known, for example, from German patent application DE 103 50 516 A.

The exhaust-gas cleaning device according to the invention comprises the following:
a) a housing through which an exhaust gas stream can flow (and which can be or is connected to an exhaust-gas channel of an internal combustion engine);
b) an exhaust-gas cleaning component that is arranged in the housing and that has a support through which the exhaust gas stream can flow and which has a front face on the inlet side and on the outlet side;
c) at least one separating element that is arranged upstream from the exhaust-gas cleaning component and that divides an exhaust-gas flow path into at least two parallel flow paths; and
d) at least one sealing means present in the area of the front face of the support on the inlet side and/or in the area of a downstream end of the separating element, said sealing means being suitable to counter a cross flow of the exhaust gas stream between the at least two parallel flow paths.

The presence of the sealing means hinders or even completely prevents the cross flow of the exhaust gas stream between the flow paths upstream from the support. Consequently, the at least two parallel flow paths upstream from the exhaust-gas cleaning component are separated from each other up to the front face of their support on the inlet side. In this manner, exhaust gas can be systematically fed to certain zones of the support, whereas exhaust gas does not flow through other areas.

When two or more flow paths are sealed off from each other, especially the high temperatures that occur as well as the large temperature differences that occur as a function of the operating point have to be taken into consideration. In particular, the temperature differences lead to significant thermal expansions of the various components. For this reason, it is not permitted for the downstream end of the separating element of the parallel flow paths to come into direct contact with the front face of the support since this could subject the components to high stresses or could even damage them.

In a preferred embodiment of the invention, the at least one sealing means comprises a groove which is created in the support and into which the downstream end of the separating element and/or another sealing means (that is attached to the separating element) of the above-mentioned type extends. Owing to the above-mentioned thermal expansions of the components, the downstream end of the separating element preferably ends at a certain distance, that is to say, without making contact with the groove bed. The configuration of the sealing means in the form of a groove in the support functions in the manner of a labyrinth seal (also called a gap seal) in which the cross flow of the exhaust gas stream is reduced between the flow paths by means of deflections and a lengthening of the flow path in the gap that is to be sealed as well as by means of the formation of baffles.

According to another embodiment of the invention, the at least one sealing means comprises a sealing element that is attached to the downstream end of the support and that is elastically in contact with the front face of the support or—in case a groove has been created into the support—with the groove (the groove bed). Here, within the scope of the present invention, the term “elastically in contact” refers to a reversible yieldingness of the sealing element in the axial direction, thereby taking into consideration the thermal expansions of the components, which can be expected during the operation of the exhaust-gas cleaning device. Preferably, the axially elastic yieldingness of the sealing element is selected in such a way that there is still contact between the sealing element and the support, even at the maximum temperature-induced distance that is to be expected between the separating element and the support.

According to a first embodiment, such a sealing element comprises a brush element having several brushes that are in contact with the front face of the support or, if applicable, with the groove (especially the groove bed) of the support. Here, the brushes can be configured as metal wires that are made, for example, of stainless steel, nickel or a nickel alloy. The number and density of the brushes should be selected in such a way that a sufficient sealing effect between the flow paths is achieved.

In an alternative embodiment, the sealing element comprises a spring plate having a plurality of slots that run diagonally in the axial direction (that is to say, in the flow direction of the exhaust gas), in other words, at a slanted angle relative to the axial direction. The lamellar structure of the spring plate created by the slots ensures a certain amount of elasticity in the axial direction and thus a sealing effect, even at different temperatures and expansions of the components. The spring plate is preferably made of a heat-resistant and corrosion-resistant material, for example, stainless steel, nickel or a nickel alloy. In another configuration, the sealing element also encompasses a sealing mat that surrounds the spring plate, at least on one side. In this manner, the cross flow is reduced even further by the slots of the spring plate and a mechanical damping effect is achieved. Especially ceramic fibers and glass fibers are options as materials for the sealing mat.

The division of the flow path upstream from the exhaust-gas cleaning component can be implemented with various geometries. According to a first embodiment, the separating element is configured as an inner tube, for instance, with a round or oval cross section, and it is arranged on the inside of the housing, preferably coaxially. It is likewise conceivable for two or more inner tubes having different diameters to be arranged concentrically so that, during operation, the streams flow over the exhaust-gas cleaning component in the form of several separate ring zones. In an alternative embodiment, the separating element is configured as a partition that passes through the housing radially (centrally or off-center) and that can have a planar or any other desired contoured shape. For example, a planar partition that passes through the housing centrally can be provided, so that the exhaust-gas path is divided into two flow paths in the form of semi-circles or semi-ellipses. By the same token, several partitions running in parallel can be provided, or else several intersecting partitions that divide the flow path into circular segments. Fundamentally, the term “parallel flow paths” as used within the scope of the present invention is not to be construed in the strict geometric sense, but rather, from a fluid mechanics perspective, in the sense of a flow that can take place through such paths selectively.

According to a preferred embodiment of the invention, in the area of an axial projection of the separating element onto the support, the support of the exhaust-gas cleaning component has a zone that is essentially flow-impermeable. In this context, the term “axial projection of the separating element” refers to the imaginary connection surface of the separating element when the latter is fictively lengthened in the flow direction of the exhaust gas and would thus touch the front face of the support. The axial projection of the separating element on the support corresponds, in a manner of speaking, to the “slipstream” of the separating element. Owing to the presence of the flow-impermeable zone, the sealing effect of the device is reduced even further as far as a cross flow of the exhaust gas between the parallel flow paths is concerned. Such a flow-impermeable zone can be implemented, for example, in that the support has a plurality of flow channels running axially which, in the area of the flow-impermeable zone, are either absent or closed off on the inlet side.

In a preferred embodiment of the invention, the exhaust-gas cleaning component has at least two zones in the radial direction with different functionalities, whereby these zones correspond to the at least two upstream flow paths, that is to say, they are essentially flush with them. In this manner, the exhaust-gas stream can be selectively and systematically guided to certain zones of the exhaust-gas cleaning component in order to utilize these functionalities in a targeted manner. In particular, the zones of the exhaust-gas cleaning components can have the functionality of an exhaust-gas catalyst, for instance, an oxidation catalyst, a reduction catalyst or a three-way catalyst, an adsorber, for instance, an HC adsorber or an NOₓ adsorber, or else a particle filter. Such functionalities can be implemented in a familiar manner by means of suitable coatings and/or by means of the geometric configurations of the flow channels. Optionally, the zones of the exhaust-gas cleaning component can also encompass a function-free zone through which the exhaust gas is merely conducted without any catalytic functions or retention functions coming to the fore.

In a special embodiment, the first zone has the functionality of an HC adsorber while a second zone has the functionality of a three-way catalyst, or else it is function-free. In this embodiment, the HC adsorber zone serves to retain hydrocarbons after a cold start of the internal combustion engine. As soon as an upstream pre-catalyst or the actual three-way catalyst of the second zone has reached its operating temperature, at least in certain areas, the exhaust-gas stream is switched over to pass through the second zone while bypassing the HC adsorber zone. Then, when a downstream three-way catalyst or oxidation catalyst has also reached its operating temperature, the exhaust-gas stream is once again diverted to the first zone via the HC adsorber, so that the hydrocarbons are desorbed and then converted in the downstream catalyst.

According to another aspect, the invention relates to an exhaust-gas system, especially for an internal combustion engine, that comprises an exhaust-gas cleaning device according to the invention. In an advantageous manner, this exhaust-gas system can be part of a motor vehicle.

Other advantageous embodiments of the invention are the subject matter of the other subordinate claims.

The invention will be explained below on the basis of embodiments. The following is shown:

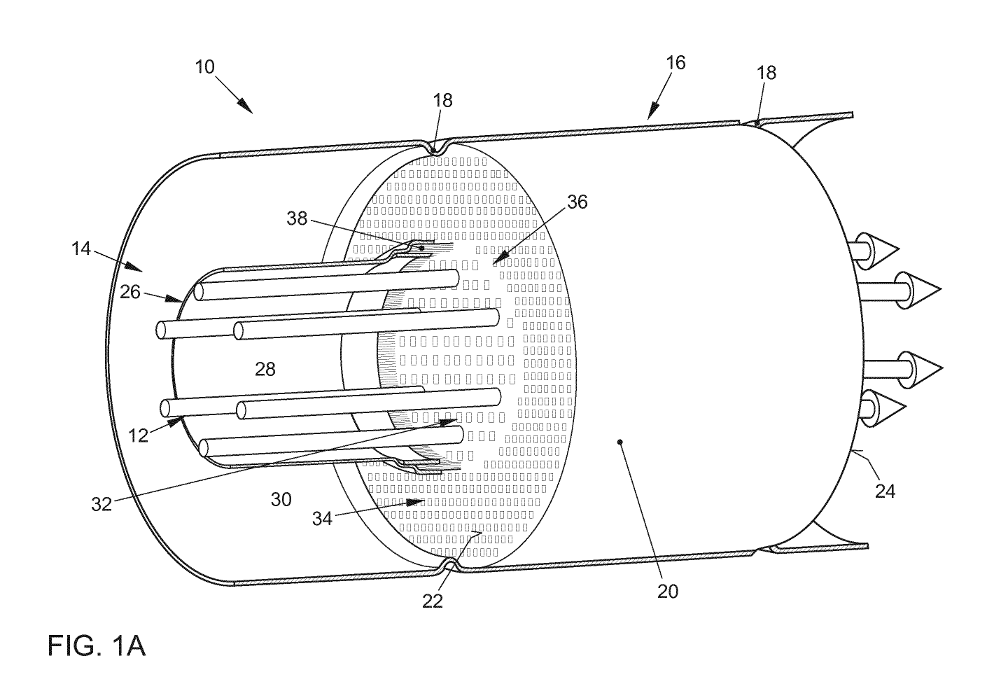

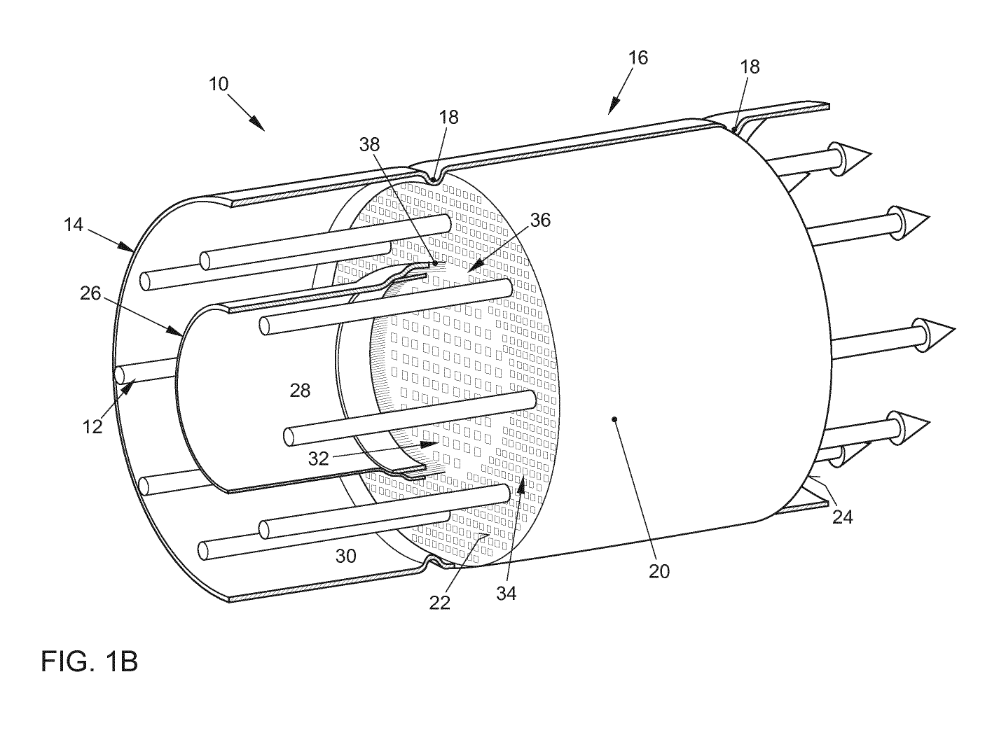

FIG. 1 a perspective, partial cutaway view of an exhaust-gas cleaning device according to the invention in a first embodiment having a ring-shaped brush element as the sealing means in the case of (A) a central flow, and (B) a peripheral flow;

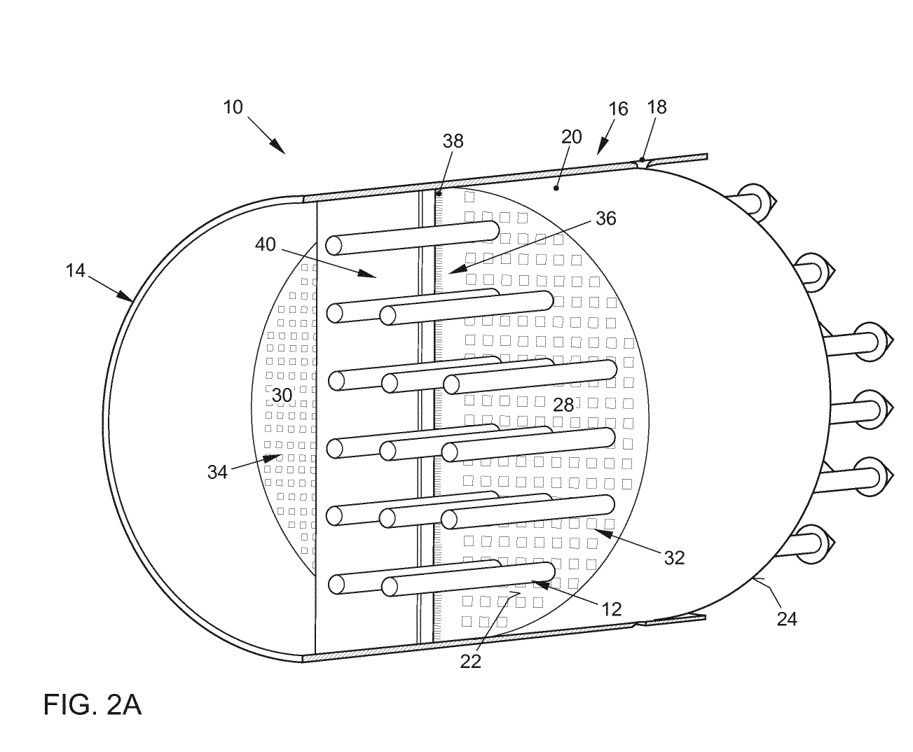

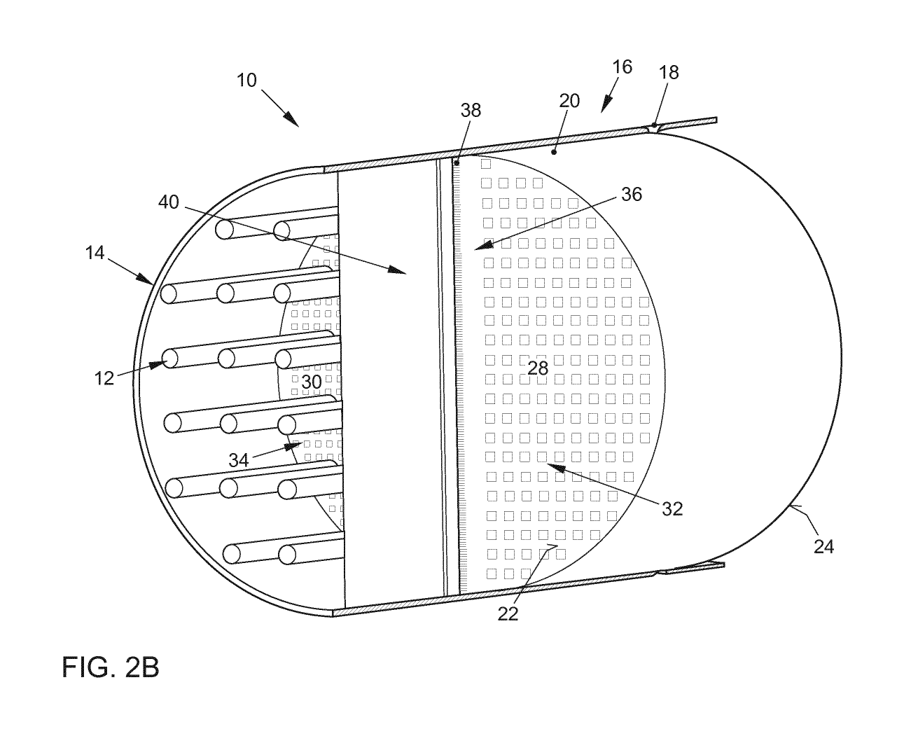

FIG. 2 a perspective, partial cutaway view of an exhaust-gas cleaning device according to the invention in a second embodiment having a straight brush element as the sealing means in the case of (A) a flow through the first flow path, and (B) a flow through the second flow path;

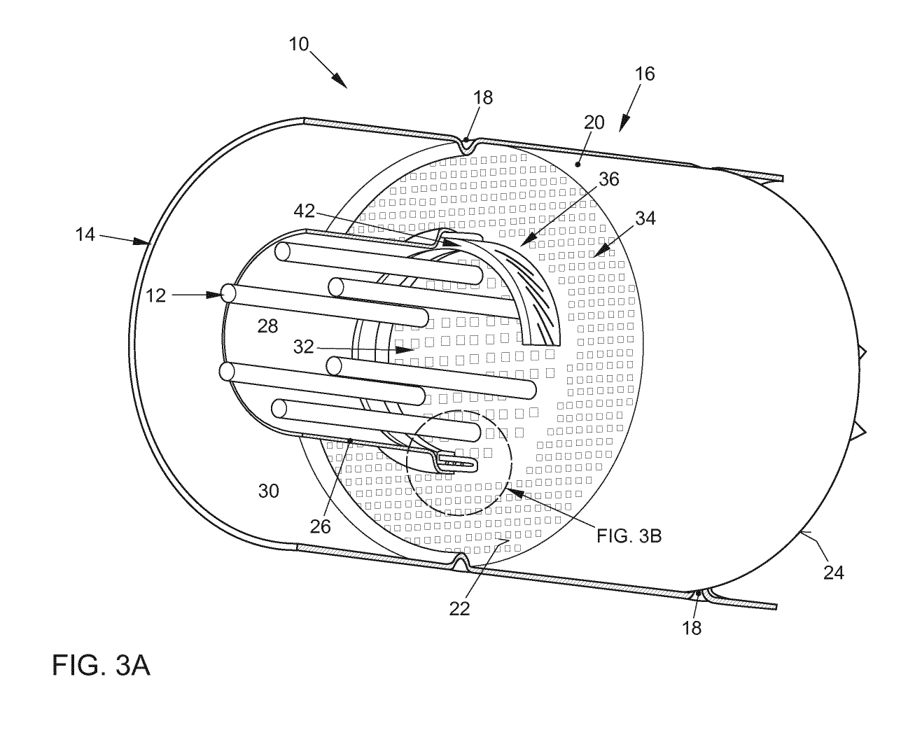

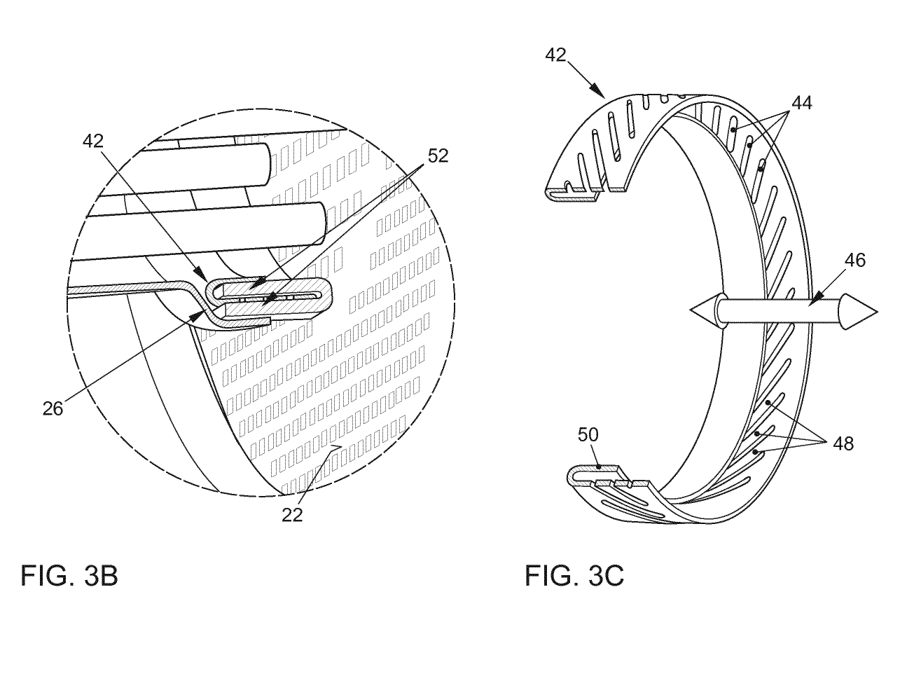

FIG. 3 an exhaust-gas cleaning device according to the invention in a third embodiment, with a spring ring as the sealing means (A) in a perspective, partial cutaway view, (B) in a detailed sectional view, and (C) in a detailed view of the spring ring;

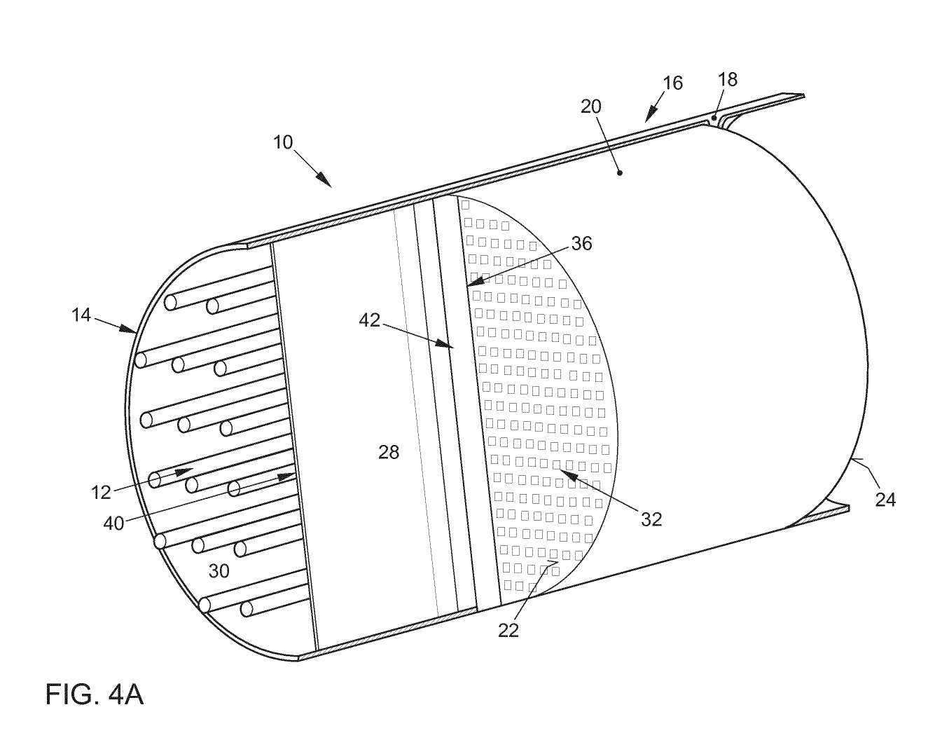

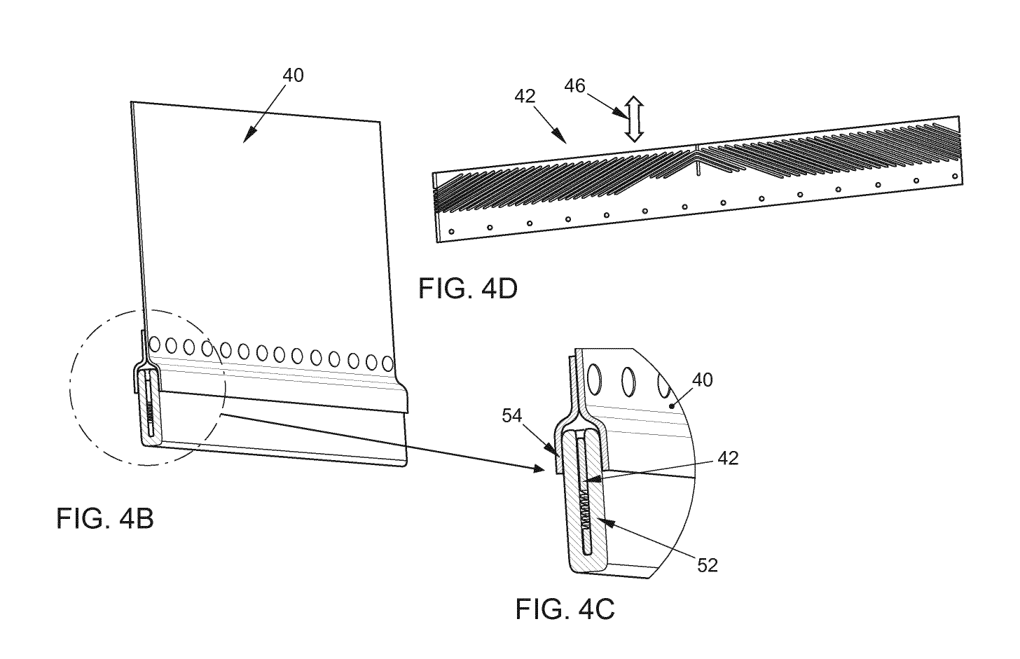

FIG. 4 an exhaust-gas cleaning device according to the invention in a fourth embodiment, with a straight spring plate as the sealing means (A) in a perspective, partial cutaway view, (B) in a detailed view of the partition with the spring plate, (C) in a detailed view of the partition with a spring plate, and (D) in a detailed view of the spring plate;

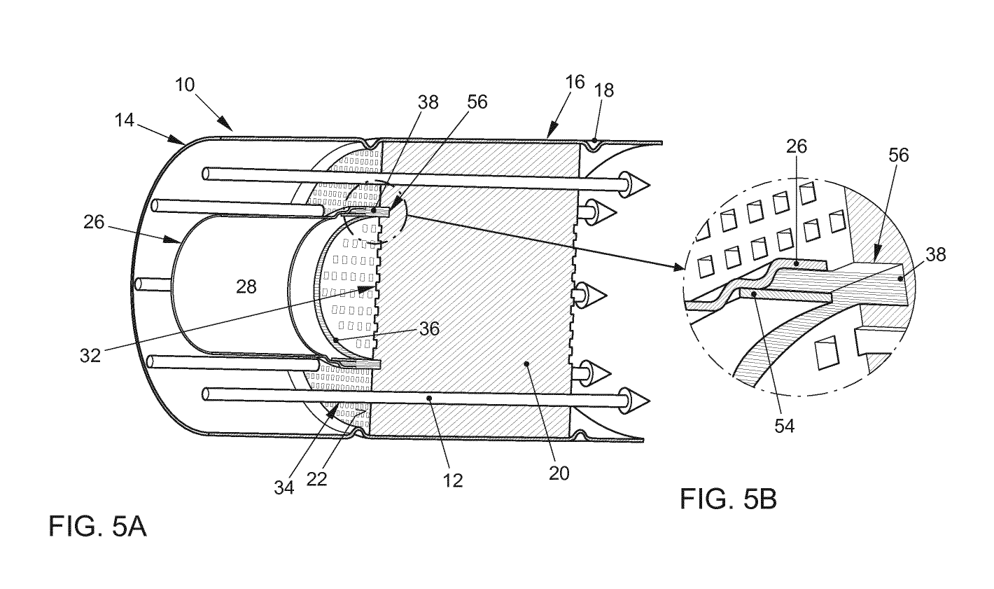

FIG. 5 an exhaust-gas cleaning device according to the invention in a fifth embodiment, with a ring-shaped brush element and an annular groove in the support as the sealing means (A) in a perspective, partial cutaway view, and (B) in a detailed view;

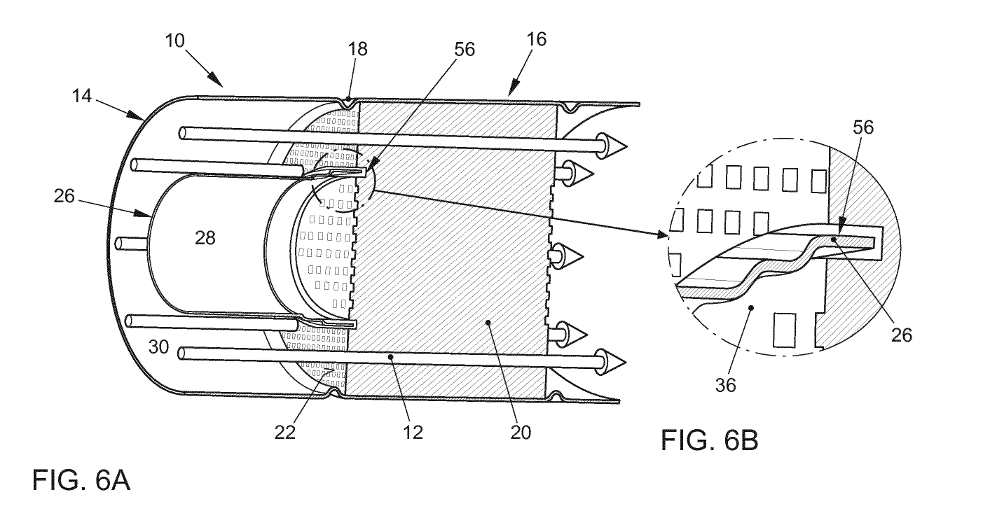

FIG. 6 an exhaust-gas cleaning device according to the invention in a sixth embodiment, with an annular groove in the support as the sealing means (A) in a perspective, partial cutaway view, and (B) in a detailed view; and

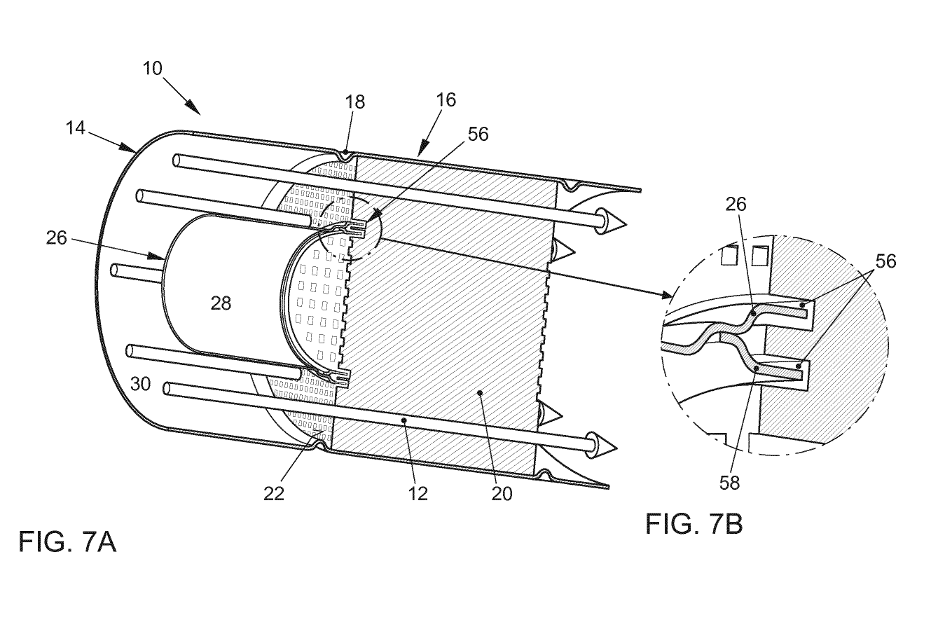

FIG. 7 an exhaust-gas cleaning device according to the invention in a seventh embodiment, with two annular grooves as the sealing means (A) in a perspective, partial cutaway view, and (B) in a detailed view.

First of all, FIGS. 1A and 1B will serve to illustrate an exhaust-gas cleaning device according to the invention in a first embodiment in which the sealing means encompass a ring-shaped brush element.

The exhaust-gas cleaning device 10 shown in FIGS. 1A and 1B comprises a housing 14 through which an exhaust gas stream (indicated by the reference numeral 12) flows from the left to the right in the figure. The housing 14 has a circular cross section here, but it can also have any other shape, for example, an oval cross section. The housing 14 can consist of a single piece or else, in a familiar way, it can be made up of several parts, especially of two half-shells. The housing 14 is joined to an internal combustion engine via an exhaust-gas channel (not shown here), for which purpose it can have flange connections, for example, on its inlet and outlet areas (likewise not shown here). Optionally, the housing 14 can also have inlet and outlet funnels that taper conically and that constrict the flow cross section so that it is the same as that of the exhaust-gas channel.

In the housing 14, there is an exhaust-gas cleaning component 16 that is affixed in the axial direction, in other words, in the flow direction of the exhaust gas 12, by two cross-section constrictions 18 (narrowed sections). Additional fixation and impact damping of the exhaust-gas cleaning component 16 can be attained in a known manner by surrounding them radially with a mat (not shown here), especially with a so-called intumescent mat.

The exhaust-gas cleaning component 16 comprises a support 20 having a front face 22 on the inlet side as well as a front face 24 on the outlet side. The support 20 has a plurality of flow channels that pass through the support in the axial direction. For instance, the support 20 can be configured as a monolith made of a ceramic material. As an alternative, it is likewise possible to use supports that are made of a rolled metal plate. The walls of the flow channels can have a coating (so-called washcoat) which gives the exhaust-gas cleaning component 16 its desired functionality. For example, the coating can comprise a catalytically active component, especially a noble metal, or else a storage component for the reversible storage of certain exhaust-gas components. By the same token, the support 20 can have a particle-retention function, thanks to a suitable design of the flow channels.

Inside the housing 14, upstream from the exhaust-gas cleaning component 16, there is a separating element 26 that divides the flow path of the exhaust gas into two parallel flow paths. In the example at hand, the separating element is configured as an inner tube 26 that divides the exhaust-gas path into a central flow path 28 and an annular, peripheral flow path 30. The exhaust-gas cleaning device 10 also encompasses means (not shown here) with which the exhaust-gas stream can be selectively guided into the first flow path 28 or into the second flow path 30. Optionally, these means can also be configured to be continuously adjustable so that any desired division of the exhaust-gas stream into the two flow paths 28, 30 is possible. For instance, these baffles can have an adjustable flap that is arranged at an inlet area of the inner tube 26. An example of a suitable arrangement is described in German patent application DE 10 350 516 A1. In the position shown in FIG. 1A, the exhaust-gas stream 12 is conveyed through the first, central flow path 28, whereas according to FIG. 1B, the exhaust gas is guided through the second, peripheral flow path 30.

Depending on the selection of the flow path 28 or 30, the exhaust gas enters different zones of the support 20, namely, a first zone 32 comprising a central area of the support 20 that corresponds to the first flow path 28, or else a second zone 34 having an annular geometry corresponding to the second flow path 30.

The various zones 32, 34 of the exhaust-gas cleaning component 16 can have different functionalities in terms of their coating and/or the geometric design of their flow channels. In a special embodiment, for example, the peripheral annular zone 34 can have an HC adsorber coating so that, up to a certain temperature limit, hydrocarbons are reversibly adsorbed. At the same time, the central zone 32 can be function-free, that is to say, not have any coating, or else it can have a three-way catalytic coating. By the same token, the diameter and cell densities of the flow channels of the various zones 32, 34 can be selected so as to differ. For instance, as shown here, the flow channels of the peripheral zone 34 can be configured so as to be smaller and to have a larger number of cells than the central zone 32. Owing to the smaller diameter and the greater cell density, a high specific surface area and thus a higher efficiency are achieved for the catalytic coating.

In the example shown, the support 20 has a flow-impermeable zone 36 which is characterized in that, in this area, there are no flow channels in the support 20 or else these flow channels are closed on the inlet side. The arrangement of the flow-impermeable zone 36 matches an axial projection of the inner tube 26 on the support 20 or, to put it in other words, it corresponds to the “slipstream” of the separating element 26. Together with the sealing means that are still to be elaborated on, the flow-impermeable zone 36 ensures a reduction of the cross flow of the exhaust-gas stream 12 between the flow paths 28 and 30.

According to the invention, in the area of the front face 22 of the support 20 on the inlet side and/or in the area of the downstream end of the separating element 26, there are sealing means 38 that counter the cross flow of the exhaust gas between the parallel flow paths 28 and 30. In the present example shown in FIGS. 1A and 1B, this sealing means is configured as a brush element 38, here in the form of a ring-shaped brush element. The brush element 38 has a plurality of brushes that are elastically in contact with the front face 22 of the support 20, especially on the flow-impermeable zone 36. The brushes are made of a heat-resistant and chemically inert material, for instance, of a noble metal, nickel or a nickel alloy. As shown here, the brush element 38 can be mounted or pressed by means of a ring plate welded onto the downstream end of the inner tube 26. Of course, other ways to attach the sealing means 38 to the separating element 26 are likewise conceivable.

Thanks to the sealing means 38, a systematic flow towards the zones 32 and 34 can be achieved while largely avoiding leakage flows. At the same time, the elastic configuration of the sealing means 38 avoids a direct contact between the separating element 28 and the front face 22 of the support 20. This prevents thermal stresses between these components as well as damage to them.

An exhaust-gas cleaning device according to a second embodiment of the invention is explained on the basis of FIGS. 2A and 2B, whereby the sealing means comprise a flat brush element. Also in the case of the figures below, corresponding elements are designated by the same reference numerals as in the previous figures and will not be elaborated upon again.

Diverging from the embodiment shown in FIGS. 1A and 1B, the separating element is configured here as a partition 40 that passes through the housing 14 radially and centrally. Even though the partition 40 shown has a planar design, other contours are likewise conceivable. The partition 40 divides the exhaust-gas stream into two radially adjacent flow paths 28, 30, each having the shape of a half-cylinder. Here, the exhaust-gas stream can be switched between the two flow paths 28, 30 by means of an exhaust-gas flap (flap valve) (not shown here) articulated in the upstream area of the partition 40. Diverging from the embodiment shown, the partition 40 can also be arranged off-center, so that exhaust-gas paths of different sizes are created. Likewise possible is an embodiment with more than one partition 40, so that three or more flow paths are formed and the exhaust-gas cleaning component 16 forms more than two zones that are exposed to the a flow.

Corresponding to the straight configuration of the partition 40, the brush element 38 likewise has a straight shape. Aside from that, the brush element 38 can be configured as described in FIGS. 1A and 1B.

A third embodiment of the exhaust-gas cleaning device according to the present invention will be explained on the basis of FIGS. 3A to 3C.

Similarly to the first embodiment according to FIGS. 1A and 1B, it is also the case in the third embodiment that the separating element is configured as an inner tube 26 arranged coaxially in the housing 14. Diverging from FIGS. 1A and 1B, the sealing means according to the third embodiment, however, comprise a sealing element configured as a spring plate 42.

The spring plate 42 shown in greater detail in a single view in FIG. 3C has a plurality of slots 44 which, however, run slanted with respect to the axial direction (indicated by the double-pointed arrow 46) on a parallel plane, in other words, at a slanted angle relative to the axial direction 46. A lamella 48 is formed between every two slots 44. Due to the material weakening brought about by the slots 44, the spring plate 42 yields elastically in the axial direction 46. The spring plate 42, which can fundamentally be made of the same material as the brush element according to the first and second embodiments of the invention, can optionally have a bent-over section 50 whose function can be seen in the detailed view in FIG. 3B.

FIG. 3B shows a section of the downstream end of the inner tube 26 whose cross section is enlarged in this area, thereby securing the annular spring plate 42. For instance, the spring plate 42 can be welded in this area to the inner tube 26. As can be seen in FIG. 3B, the area of the spring plate 42 that has the slot 44 is surrounded on both sides by a sealing mat 52. Here, the ends of the sealing mat 52 are pressed, on the one hand, between the inner tube 26 and the spring plate 42 and, on the other hand, between the spring plate 42 and its folded-over section 50. The spring plate 42 or the sealing mat 52 are in contact in an elastically yielding manner with the front face 22 of the support 20, especially on the flow-impermeable zone 36. Even though the spring plate 42 alone already brings about a significant reduction of the cross flow between the flow paths 28 and 30, the sealing mat 52 provides an additional sealing effect. In addition, the sealing mat 52 brings about additional impact damping between the inner tube 26 and the support 20, while also preventing stresses.

An exhaust-gas cleaning device 10 according to a fourth embodiment of the invention is explained with reference to FIGS. 4A to 4D. As was the case in the second embodiment of the invention (see FIGS. 2A and 2B), here, too, the separating element is configured as a planar partition 40 that divides the flow path into two parallel, radially adjacent flow paths 28 and 30. Accordingly, the spring plate 42 arranged on the downstream end also has a flat shape.

FIG. 4D shows a single view of such a spring plate 42 having an arrangement pattern of slots 44 by way of an example. Due to the plurality of slots 44 that run diagonally, the spring plate 42 can be elastically compressed in the axial direction 46.

As can be seen in FIGS. 4B and 4C, the spring plate 42 can be surrounded by a sealing mat 52. The structure consisting of the spring plate 42 and the sealing mat 52 is pressed between the end section of the partition 40 and a holding plate 54 that is welded to the partition 40.

A fifth embodiment of the invention is shown in FIGS. 5A and 5B. The exhaust-gas cleaning device 10 shown here corresponds essentially to the first embodiment according to FIGS. 1A and 1B. In particular, the downstream end of the inner tube 26 is fitted with a ring-shaped brush element 38 that is pressed in by a welded-on holding plate 54 (see the detailed sectional view in FIG. 5B). Diverging from the first embodiment, the fifth embodiment of the exhaust-gas cleaning device 10, however, is characterized by a groove 56 that has been created in the support 20, namely, in the area of its front face 22. A sealing means configured as a brush element 38 extends into the groove 56. Here, the brush element 38 is preferably in contact with the bed of the groove 56. The fifth embodiment of the exhaust-gas cleaning device combines the function of a labyrinth seal brought about by the groove 56 with the sealing effect of a sealing element, here in the form of a brush 38.

A sixth embodiment of the exhaust-gas cleaning device 10 according to the invention is shown in FIGS. 6A and 6B. This embodiment corresponds essentially to the fifth embodiment shown in FIGS. 5A and 5B. Diverging from the latter, however, there is no sealing element, especially no brush element. Rather, the downstream end of the inner tube 26 extends, preferably contact-free, into the groove 56 of the support 20. In this embodiment, the sealing effect that counters any leakage flow between the flow paths 28 and 30 stems exclusively from the function of a labyrinth seal.

A seventh embodiment of the exhaust-gas cleaning device 10 according to the invention is shown in FIGS. 7A and 7B, which is essentially a refinement of the sixth embodiment. Diverging from the sixth embodiment of the exhaust-gas cleaning device, the seventh embodiment has two sealing grooves 56 that have been created parallel or concentrically in the support 20 of the exhaust-gas cleaning component 16. In this embodiment, the downstream end of the separating element configured as an inner tube 26 has a sealing plate 58 that especially has been welded on. Here, the separating element 26 as well as the sealing plate 58 both extend, preferably contact-free, into one of the two sealing grooves 56. The sealing effect of the seventh embodiment is thus based on a double labyrinth seal. Of course, the double labyrinth seal according to this embodiment can also be combined with a sealing element, especially a brush element and/or a spring plate.

### LIST OF REFERENCE NUMERALS

10 exhaust-gas cleaning device
12 exhaust-gas stream
14 housing
16 exhaust-gas cleaning component
18 cross section constriction/narrowed section
20 support
22 front face on the inlet side
24 front face on the outlet side
26 separating element/inner tube
28 first flow path
30 second flow path
32 first zone of the exhaust-gas cleaning component
34 second zone of the exhaust-gas cleaning component
36 flow-impermeable zone
38 sealing element/brush element
40 separating element/partition
42 sealing element spring plate
44 slot
46 axial direction
48 lamella
50 folded-over section
52 sealing mat
54 holding plate
56 groove
58 sealing plate

1. An exhaust-gas cleaning device, comprising:
a) a housing through which an exhaust gas stream can flow;
b) an exhaust-gas cleaning component that is arranged in the housing and that has a support through which the exhaust gas stream can flow and which has a front face on the inlet side and on the outlet side;
c) at least one separating element that is arranged upstream from the exhaust-gas cleaning component and that divides an exhaust-gas flow path into at least two parallel flow paths; and
d) at least one sealing means present in the area of the front face of the support on the inlet side and/or in the area of a downstream end of the separating element, said sealing means being suitable to counter a cross flow of the exhaust gas stream between the at least two parallel flow paths.

2. The exhaust-gas cleaning device according to claim 1, whereby the at least one sealing means comprises a groove which is created in the support and into which the downstream end of the separating element and/or another sealing means extends.

3. The exhaust-gas cleaning device according to claim 1, whereby the at least one sealing means comprises a sealing element that is attached to the downstream end of the separating element and that is elastically in contact with the front face or with the groove of the support.

4. The exhaust-gas cleaning device according to claim 3, whereby the sealing element comprises a brush element having several brushes that are in contact with the front face or with the groove of the support.

5. The exhaust-gas cleaning device according to claim 3, whereby the sealing element comprises a spring plate having a plurality of slots that run diagonally in the axial direction.

6. The exhaust-gas cleaning device according to claim 5, also encompassing a sealing mat that surrounds the spring plate.

7. The exhaust-gas cleaning device according to claim 1, whereby the separating element is configured as an inner tube arranged on the inside of the housing, especially coaxially.

8. The exhaust-gas cleaning device according to claim 1, whereby the separating element is configured as a partition that passes through the housing radially and that has a planar or any other desired contoured shape.

9. The exhaust-gas cleaning device according to claim 1, whereby, in the area of an axial projection of the separating element onto the support, the support has a flow-impermeable zone.

10. The exhaust-gas cleaning device according to claim 1, whereby the exhaust-gas cleaning component has at least two zones in the radial direction with different functionalities, whereby these zones are flush with the at least two flow paths.

11. The exhaust-gas cleaning device according to claim 10, whereby the zones of the exhaust-gas cleaning component are configured with the functionality of an exhaust-gas catalyst, an adsorber, a particle filter, or else they are function-free.

12. The exhaust-gas cleaning device according to claim 11, whereby a first zone has the functionality of an HC adsorber while a second zone has the functionality of a three-way catalyst, or else it is function-free.

13. An exhaust-gas system comprising an exhaust-gas cleaning device according to claim 1.
